(19) United States
(12) Patent Application Publication
(10) Pub. No.: US 2005/0175258 A1
(43) Pub. Date: Aug. 11, 2005

(54) Method and apparatus for downscaling digital image data to fit a graphics display device

(76) Inventors: Patrick Wai-Tong Leung, Vancouver (CA); Juraj Bystricky, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/776,358

(22) Filed: Feb. 11, 2004

(51) Int. Cl. G06K 9/32

(52) U.S. Cl. 382/299

(57) ABSTRACT

A method and apparatus for downscaling digital image data to fit a graphics display device. The method and apparatus provide for sampling a sequence of image data so that (N−M)+/−1 pixels, preferably N−M pixels, of the image data are sampled for every N pixels of said sequence, where M and N are integers and M<N. Preferably, N=2ⁿ, where n is a positive integer.

### FIELD OF THE INVENTION

The present invention relates to a method and apparatus for downscaling digital image data to fit a graphics display device. More particularly, the invention relates to such a method and apparatus that provides for downscaling the image data so that the image represented thereby precisely matches the dimensions of the graphics display device.

### BACKGROUND

Graphics display devices, such as liquid crystal display (“LCD”) panels, have fixed horizontal and vertical dimensions. Therefore it is often necessary, especially when providing a camera image to the display device, to scale down, or “downscale,” the camera image to fit the display device. The conventional method for such downscaling is known in the art as 1/N scaling, where N is an integer. The method operates on a sequence of pixels, which may be a stream of transmission or a sequence in memory. The method either samples or does not sample pixels in the sequence according to the output of a counting circuit. The counting circuit is adapted to count clock pulses generated by a clock source, and the clock pulses correspond, respectively, to the pixels in the sequence. The counting circuit repeatedly counts to N and resets, providing a reset signal as an output to a pixel select circuit The pixel select circuit selects only those pixels corresponding to clock pulses that are coincident with the reset signal, and conversely omits selecting those pixels corresponding to clock pulses that are not coincident with the reset signal. For example, if N=1, defining 1 as the scale factor, every clock pulse is accompanied by a corresponding reset signal, and the sampling circuit samples every pixel. Where N=3, defining ⅓ as the scale factor, every third clock pulse is accompanied by a corresponding reset signal, and the sampling circuit samples every third pixel.

A problem with this conventional 1/N scaling method is that the available scale factors do not necessarily permit sizing the data precisely to fit the display. For example, fitting a 352×288 pixel image to a display screen that is 132×160 pixels would require horizontal and vertical scale factors of 0.375 ( 132/352) and 0.55 ( 160/288) respectively. Using the conventional 1/N scaling method, a horizontal scale factor of 0.333 (⅓) and a vertical scale factor of 0.5 (½) would provide the closest matches. However, with the conventional method, the horizontal and vertical edges of the image would both be cut off.

Another problem with the conventional 1/N scaling method is that the largest amount by which an image can be downscaled is limited to 0.5 (½). The method does not permit downscaling an image by, for instance, 0.667 (⅔).

A further problem with the conventional 1/N scaling method can occur if two images are to be displayed on the display device. For example, assume that an original image is downscaled to be displayed as a first image and a second smaller image, such as a “pull-down” menu or “dialog box,” is superimposed on “top” the first image. According to the conventional method, the pixels of the first image which underlie the second image are replaced by the pixels of the second image. As a result, those pixels of the first image that underlie the second image are lost. At some point it is typically determined that it is no longer necessary to display the second image, and it becomes necessary to provide the display device with the “lost pixels” from the first image. One way to provide the display device with the lost pixels is to downscale just that portion of the original image that original produced the lost pixels. However, downscaling a portion of the original image may generate pixels that are not the same the lost pixels. The reason for this lies in the fact that the original and subsequent downscaling operations may not be synchronized.

As an example of asynchronous downscaling operations, first assume a scale factor of ½, where the count begins with the first pixel (pixel 1) of the original image, the following pixels would be sampled: 2, 4, 6, 8, 10, 12, 14 . . . i.e., even numbered pixels would be sampled. In contrast, however, when the lost pixels are created, the count does not begin with pixel 1, rather it begins with the first pixel that resulted in the first lost pixel. If this is an even numbered pixel, such as pixel 8, then pixels 9, 11, 13, 15 . . . would be sampled, i.e., odd numbered pixels would be sampled. When the recreated lost pixels are superimposed on the first image at the corresponding pixel addresses of the second image, the image would have the pixel sequence: 2, 4, 6, 9, 11, 13, 15 . . . While this is a shift of just a single pixel, it may, depending on the particular image data, result in an undesirable visual artifact.

To avoid the possibility of an artifact, typically the entire original image is downscaled a second time and presented to the display device. However, downscaling the entire image a second time is an inefficient use of image processing resources.

Accordingly, there is a need for a method and apparatus for downscaling digital image data to fit a display that provides for downscaling the image data so that the image represented thereby precisely matches the dimensions of the display.

### SUMMARY

A preferred method, apparatus, medium, and system for downscaling digital image data to fit a display provides for sampling a sequence of image data so that (N−M)+/−1 pixels, preferably N−M pixels; of the image data are sampled for every N pixels of said sequence, where M and N are integers and M<N. Preferably, N=2ⁿ, where n is a positive integer.

### BRIEF DESCRIPTION OF THE DRAWINGS

FIG. 1A is a schematic diagram of a sequence of pixels and a display for displaying the sequence of pixels.

FIG. 1B is a schematic diagram of the sequence of pixels in FIG. 1A, mapped to the display of FIG. 1A according to one alternative of 1/N scaling.

FIG. 1C is a schematic diagram of the sequence of pixels of FIG. 1A, mapped to the display of FIG. 1A according to another alternative of 1/N scaling.

FIG. 2A is a schematic diagram of the sequence of pixels of FIG. 1A, showing de-selected pixels according to a portion of a method for downscaling image data according to the present invention.

FIG. 2B is a schematic diagram of the sequence of pixels of FIG. 1A, showing additionally de-selected pixels according to another portion of a method for downscaling image data according to the present invention.

FIG. 2C is a schematic diagram of the sequence of pixels of FIG. 1A identifying all of the pixels selected and de-selected as a result of performing both portions of the method of FIGS. 2A and 2B.

FIG. 3 is a flow diagram of the method of FIGS. 2A and 2B.

FIG. 4 is a flow diagram of an alternative method for downscaling image data to fit a display according to the present invention.

FIG. 5 is a schematic view of a preferred embodiment of an apparatus for downscaling image data to fit a display according to the principles of the method of FIG. 4.

FIG. 6A is a table illustrating the state of a selected variable, in decimal, defined by the apparatus of FIG. 5 as a function of an increment input to the apparatus and the number of clock pulses received by the apparatus.

FIG. 6B is a table illustrating the state of a selected variable, in binary, defined by the apparatus of FIG. 5 as a function of an increment input to the apparatus and the number of clock pulses received by the apparatus.

FIG. 6C is a table illustrating the state of a carry signal defined by the apparatus of FIG. 5 as a function of an increment input to the apparatus and the number of clock pulses received by the apparatus.

FIG. 7 is a schematic view of an alternative preferred embodiment of an apparatus for downscaling image data to fit a display that includes a modification to the apparatus of FIG. 5 in order to provide an offset according to the present invention.

FIG. 8 is a selected portion of the table of FIG. 6A, as altered by the modification of FIG. 7 for one exemplary value of the offset.

FIG. 9 is a block diagram of a preferred graphics display system, including a display having an embedded memory, for use in conjunction with methods and apparatus according to the present invention.

FIG. 10 illustrates the display of FIG. 9 at first and second times.

FIG. 11A illustrates a portion of the memory of FIG. 9 after a downscaled image has been stored therein.

FIG. 11B illustrates the portion of the memory of FIG. 11A after a superimposed image has been stored therein.

FIG. 12 is a table illustrating the output of the apparatus of FIG. 7 and a part of the memory of FIG. 11A after a downscaled image has been stored therein.

### DETAILED DESCRIPTION OF A PREFERRED EMBODIMENT

The invention provides for downscaling digital image data to fit a graphics display device, such as an LCD, CRT, or other similar display device. Reference will now be made in detail to the present preferred embodiments of the invention, examples of which are illustrated in the accompanying drawings. Wherever possible, the same reference numbers are used in the drawings and the description to refer to the same or like parts and symbols.

An image on a display device is formed from an array of small discrete elements known as “pixels.” Typically, the display provides a rectangular array of pixels defined by horizontal and vertical numbers of pixels, e.g., 132×160. The attributes of each pixel, such as its brightness and color, are represented by a numeric value, which is typically represented in binary form. For convenience of explanation and in accordance with the use of the term in the art, the term “pixel” is used herein to refer at times to the display elements of a display device, at times to the binary elements of data that are stored and manipulated within a computer system and which define the attributes of such display elements, and at times to both, the appropriate sense of the term being clear from the context. Each array of pixels is typically referred to as a “frame.”

The pixels in a display device are generally updated or “refreshed” according to a raster scan pattern. Beginning with the left-most pixel on a top scan line of the array, pixels are updated pixel-by-pixel from left to right. After all of the pixels in the top line have been refreshed, the pixels in the second line from the top of the array are updated, again beginning with the left-most pixel. The raster scan pattern continues to each successively lower line until all of the lines in the array have been updated. Because the pixels in a frame are displayed in raster sequence, it is common to store and transmit pixels in raster sequence.

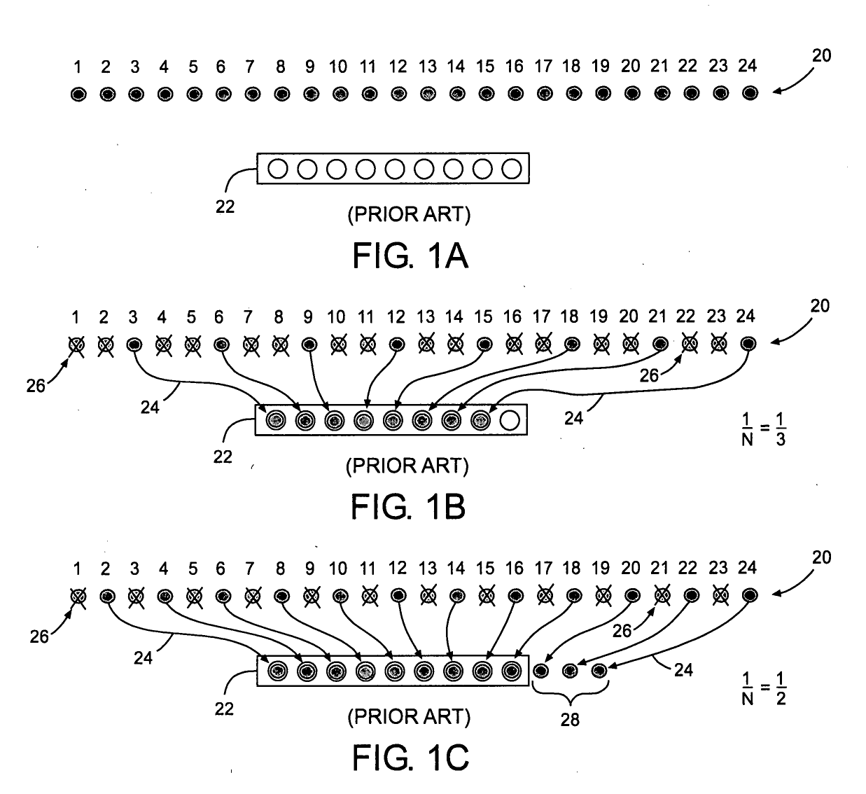

FIG. 1A shows image data in the form of an exemplary sequence of twenty-four pixels 20 for ultimate presentation to an exemplary graphics display device 22. The sequence of pixels 20 may represent a transmission of pixels, either synchronous or asynchronous, or may represent a sequence stored in a memory, such as a display buffer, and the pixels 20 are ordered in raster sequence. For simplicity of illustration, the exemplary graphics display device 22 is capable of displaying just a single line having only nine pixels. In other words, the example of FIG. 1A shows and considers only one dimension of the display device, e.g., horizontal or vertical, it being understood that similar considerations apply generally to the other dimension, and to display devices having a plurality of rows and columns of pixels, as well as to lines having any number of pixels.

In order to fit the display 22, the exemplary sequence of twenty-four pixels 20 must be downscaled to nine pixels. If the scaled-down image is to precisely fit the display panel, a scale factor of ⅜ is required. Using the conventional 1/N scaling method, however, a scale factor of ⅜ is unobtainable. Accordingly, if the conventional 1/N scaling method is used, the image data would need to be downscaled by a factor of either ⅓ or ½.

To downscale by a factor of 1/N, a counter can be used that counts in increments of one up to N and resets when the count=N. Typically, the counter is a synchronous binary counter, which outputs a count signal with each clock pulse and upon reaching N additionally outputs a reset signal. In the sequence of pixels 20, each pixel is either: (a) picked or selected for transmission to the display device; or (b) dropped or de-selected. Pixels are selected if their position in the sequence corresponds to the reset signal; otherwise, the pixels are de-selected.

For example, as indicated in FIG. 1B, if the image data were downscaled by a factor of ⅓, the pixels 20 would be mapped to the display 22, where selected pixels are indicated by arrows 24 showing that the pixels are mapped to the display 22, and de-selected pixels are indicated as not being mapped to the display and instead are shown as crossed out (by crosses 26). Since ⅓<⅜, the eight selected pixels do not fill the nine pixel display 22.

Alternatively, as indicated in FIG. 1C, if the data were downscaled by a factor of 1/2, the pixels 20 would be mapped to the display 22. Since ½>⅜, the data overflow the display device 20 and three of the selected pixels at the end of the sequence, indicated by reference number 28, are not displayed.

Neither alternative of 1/N scaling factor is satisfactory. The present invention addresses this problem by providing for improved downscaling. Particularly, it is recognized herein that M/N scaling is needed, where M and N are integers (N>M). In the example presented above of downscaling a sequence of twenty-four pixels 20 to fit the graphics display device 22 capable of displaying only a single line of only 9 pixels, M/N=⅜, that is, M=3 and N=8.

One method for providing M/N scaling is a modification of 1/N scaling. In particular, M/N may be expressed as (1/N₁−1/N₂), where 1/N₁ is the smallest 1/(integer) that is greater than M/N, and where 1/N₂=(1/N₁−M/N). For example, ⅜=½−⅛. Two counters, such as those described above, may be used: a first counter to count to N₁ and a second counter to count to N₂. Each counter defines pixels that should be de-selected or not sampled, and a pixel is de-selected if either counter indicates that the pixel should not be sampled.

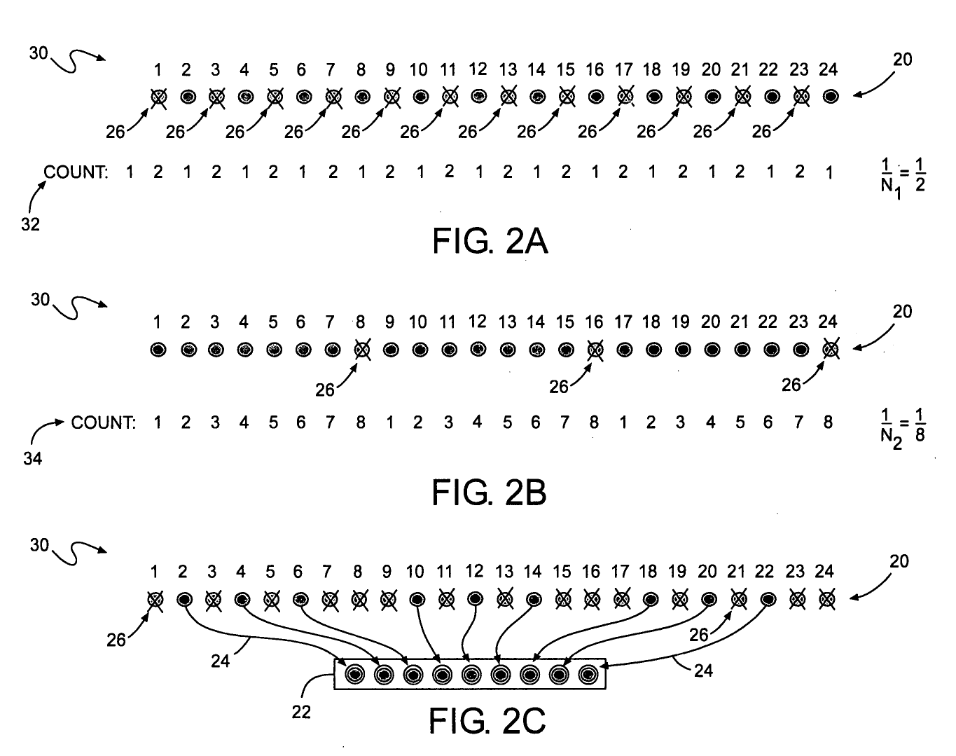

FIGS. 2A-2C illustrate such a method 30 for M/N=⅜. In FIG. 2A, a first counter (not shown) for defining a scale factor 1/N₁=½ counts to two, providing a reset signal when the count=2. The output of the first counter is labeled as count 32. Unlike the examples of FIGS. 1A-1C, the reset signal is used here to instruct a pixel drop circuit (also not shown) to de-select or not sample the corresponding pixel. (In FIGS. 1A-1C, the reset signal is used to select pixels.) As shown in FIG. 2A, pixels 1, 3, 5, 7, 9, 11, 13, 15, 17, 19, 21, and 23 are de-selected. The de-selected pixels are shown as crossed out (by crosses 26).

Turning to FIG. 2B, additional downscaling is provided by a second counter (also not shown) for defining a scale factor 1/N2=⅛. The second counter counts up to 8 and provides a reset signal when the count=8. The output of the second counter is labeled as count 34. The reset signal is used to instruct the sampling circuit to de-select or not sample the corresponding pixel. As shown in FIG. 2B, pixels 8, 16, and 24 are de-selected.

The first and second counters operate in synchronization with one another. However, an offset may be required to align the two counters so that each counter defines different pixels for de-selection. In the example shown in FIG. 2A, an offset is applied to the first counter: The count of the first counter is advanced by one in order to avoid de-selecting pixels dropped by the second counter. Alternatively, the first counter may be delayed by one. Further, in another alternative embodiment, an offset is not required. In this alternative, instead of using the reset signal to instruct the sampling circuit to drop a pixel, the reset signal can be employed to select a corresponding pixel. (This is the method employed in FIGS. 1B-1C.)

FIG. 2C shows the resulting selection and de-selection of pixels. Selected pixels are shown being mapped to the display 22, as indicated by arrows 24. As FIG. 2C shows, the selected pixels are precisely mapped to the display 22. The problem of mapping not enough or too many pixels to the display 22 is eliminated.

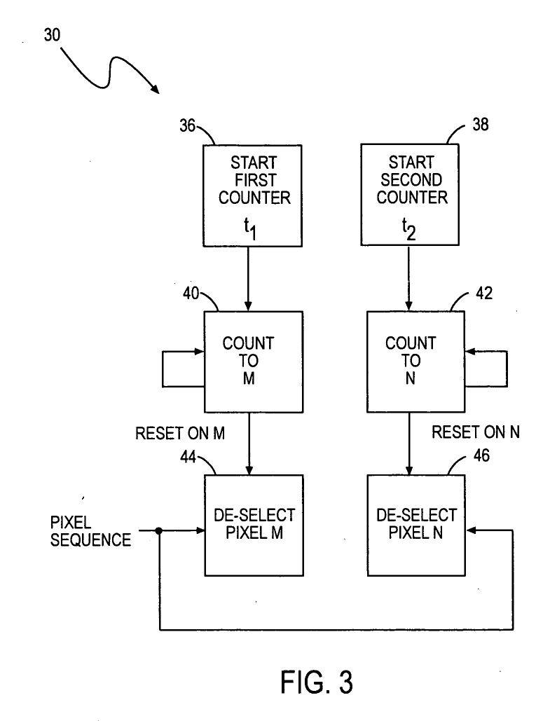

In FIG. 3, a flow chart of the method 30 is shown. At steps 36 and 38, the first and second counters are started. The times t₁ and t₂ may be the same. Alternatively, the first and second counters may be started at different times t₁ and t₂ to effectuate a desired offset. At steps 40 and 42, the first and second counters count up and reset at count=M and N respectively. At steps 44 and 46, a pixel sequence is input, and the pixels in the sequence corresponding to M or N are de-selected. Alternatively, the first and second counters may count down from M and N respectively and reset at count=0.

The method 30 provides an improved resolution whereby (N−M) pixels are dropped out of every N pixels. In the above example of M/N scaling, the method provides for dropping 5 pixels out of every 8. In this example, M/N=⅜ and N=2ⁿ, where n is equal to 3. Generally, n is an integer; and it may be noted that for large n, any ratio M/N can be approximated by a ratio M/N where N=2ⁿ, n being an integer. However, where N≠2ⁿ, the denominator in the ratio 1/N may be a fraction, in which case the fraction should be rounded to the nearest integer. Therefore, in the most general case, (N−M)+/−1 pixels out of every N pixels are dropped according to the method.

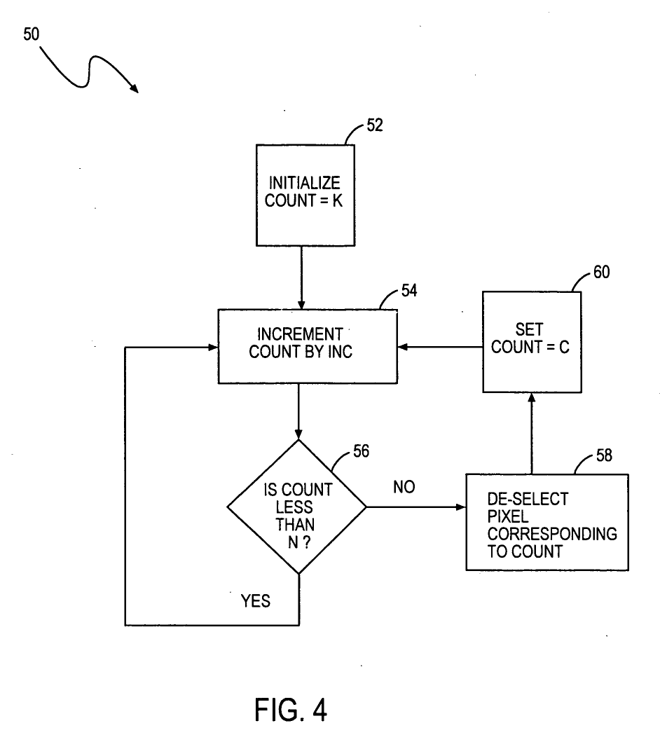

Turning to FIG. 4, a preferred method 50 for providing M/N scaling is shown. While the method 30 employs two counters, the method 50 advantageously employs just a single counter. As with the method 30, the method 50 provides M/N scaling, N=2ⁿ. The method 50 operates on a sequence of pixels and uses a variable referred to as COUNT. Each value of COUNT corresponds to the sequential number of a particular pixel in the sequence of pixels being operated on. In a step 52, COUNT is initialized to a value of “K,” where K is any desired offset. For simplicity, it may be assumed that K=0. In a step 54, COUNT is incremented by the value INC. In step 56, COUNT is compared to N. If COUNT is less than N, the method proceeds to step 54. On the other hand, if COUNT is greater than or equal to N, the method proceeds to step 58. In step 58, the pixel corresponding to COUNT is de-selected. At step 60, COUNT is set to C, where C=COUNT−N.

The method 50 may be illustrated by way of an example, where M/N=⅜ and N=2ⁿ, where n is equal to 3. In the example, K=0 and INC=N−M=3. At step 52, COUNT is initialized to zero. In step 54, Count is increased by INC so COUNT=5. At step 56, since COUNT is less than 8, the method proceeds to step 54. On the next pass through the method, COUNT=10 and the method branches from step 56 to step 58. In step 58, the pixel corresponding to the value of COUNT is de-selected. In step 60, COUNT is set to C, C being the difference between COUNT and N, that is, C=10−8=2. The method proceeds to step 54 and COUNT is increased by INC so COUNT=7. The results of the method for this example are shown below:

Pixel

| | 1 | 2 | 3 | 4 | 5 | 6 | 7 | 8 |
|---|---|---|---|---|---|---|---|---|
| COUNT | 5 | 10 | 7 | 12 | 9 | 6 | 11 | 8 |

In this example of the method, the pixels 2, 4, 5, 7, and 8 are de-selected.

Providing a non-zero value for K shifts pixel selection relative to the sequence, which is equivalent to shifting the sequence. For instance, letting K=1 in the above example, as shown below, results in the de-selection of different pixels, that is, 2, 3, 5, 7, and 8.

Pixel

| | 1 | 2 | 3 | 4 | 5 | 6 | 7 | 8 |
|---|---|---|---|---|---|---|---|---|
| COUNT | 6 | 11 | 8 | 5 | 10 | 7 | 12 | 9 |

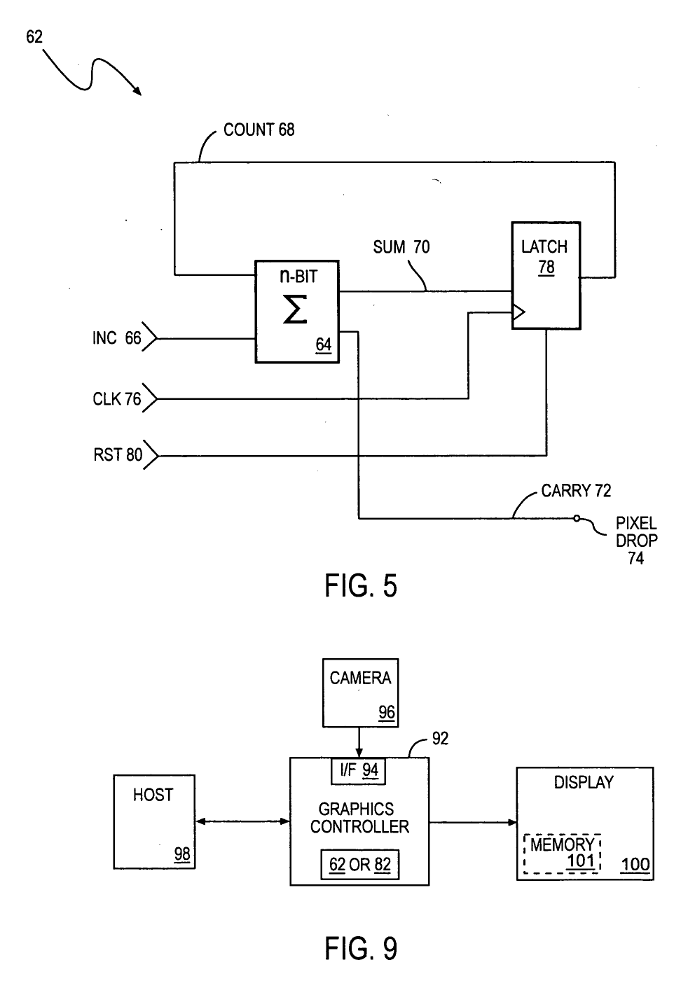

Referring to FIG. 5, a preferred sampling circuit 62 according to the method 50 is shown. The circuit employs an n-bit ADDER 64 adapted to count in increments or steps. An increment signal INC 66 is input to one of the inputs of the ADDER 64. A COUNT signal 68 representing the previous count value is input to another input. The ADDER 64 has output signals: SUM 70 and CARRY 72. A PIXEL DROP output 74 of the circuit instructs a pixel drop circuit (not shown) to drop a pixel in the pixel sequence that corresponds to a clock signal CLK 76. The output signal SUM 70 and the clock signal CLK 76 are coupled respectively to the data input and clock input of a LATCH 78. A reset signal RST 80 is coupled to the reset input of the LATCH 78.

In operation, the reset signal RST 80 is provided to the latch 78 causing it, and the value of COUNT 68, to be set to a value of zero. An increment signal INC 66 for specifying the amount of each step is provided to the ADDER 64. The ADDER 64 adds COUNT 68 and INC 66 to produce SUM 70. When the LATCH 78 receives a clock pulse CLK 76, the value on its input, SUM 70, is transferred to its output to become COUNT 68. It is in this manner that the circuit counts in a first increment or step. With each subsequent clock pulse, the COUNT 68 is incremented by INC 66. The circuit increments the COUNT 68 with each clock pulse until the SUM 70 is too large to be represented by the number of bits available in the ADDER 64 and the output signal CARRY 72 is generated. The CARRY signal causes the circuit 62 to generate a PIXEL DROP signal 74. Simultaneous with generating the CARRY signal, the circuit 62 produces a SUM signal which is used as the beginning value when the circuit resumes counting on the next clock pulse.

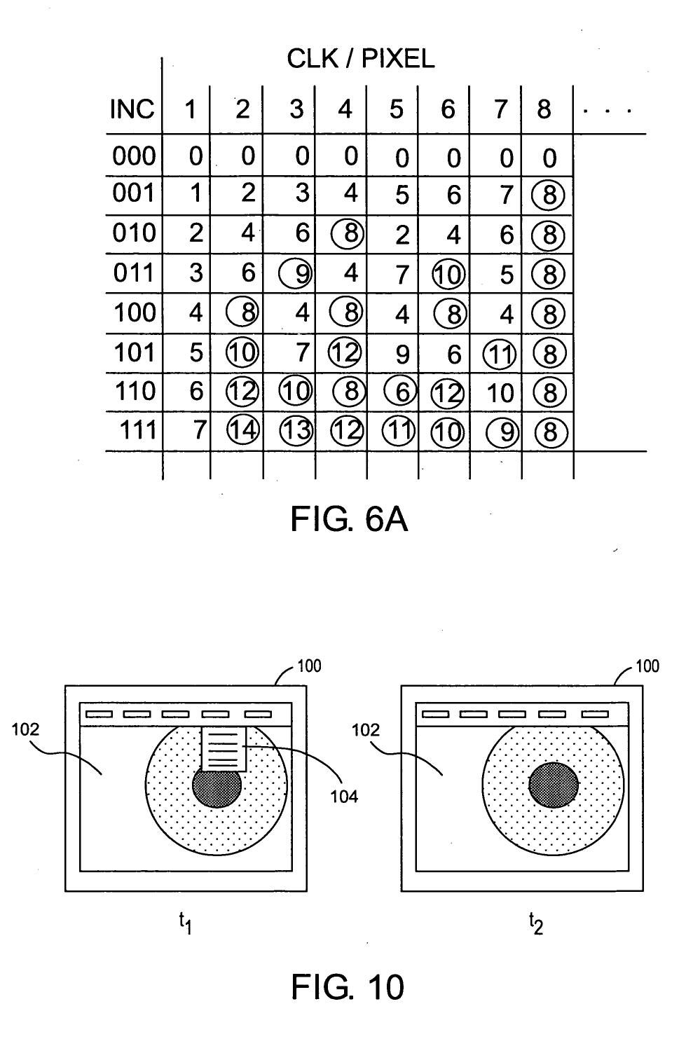

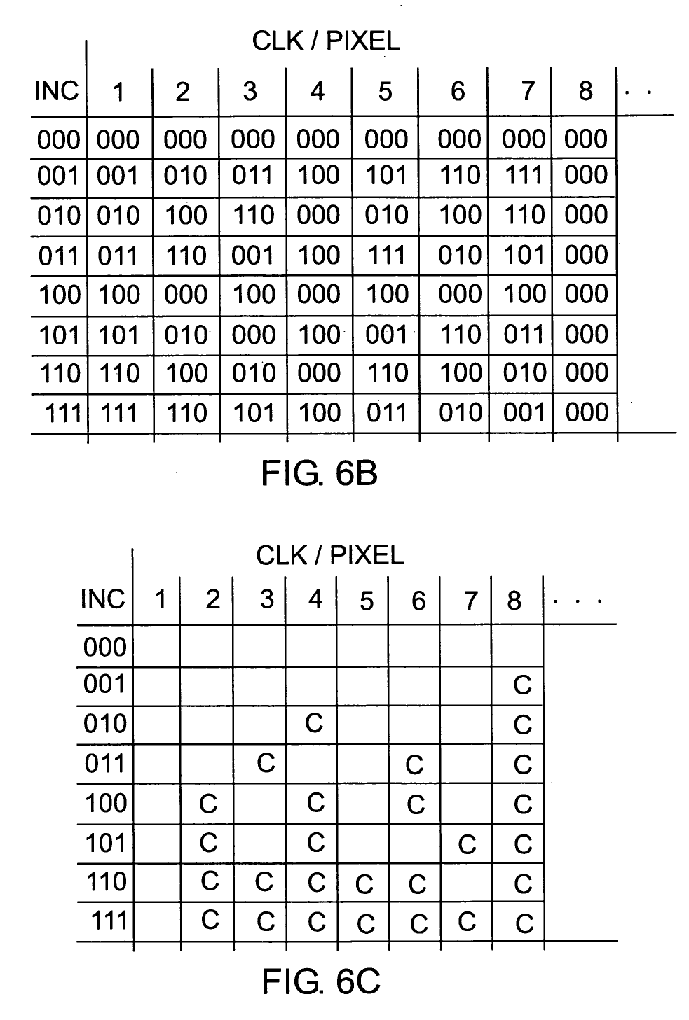

For example, assume a 3-bit ADDER. FIG. 6A is a table showing the output (converted to decimal) of the 3-bit ADDER 64 for a sequence of clock pulses 1-8, corresponding to pixels #1-8 in a pixel sequence like that discussed above. The table tabulates decimal values of SUM 70 for each clock pulse (pixel) for different binary values of INC. In the table, the columns correspond to clock pulses and pixels, and the rows correspond to different binary values of INC.

The CARRY signal 72 is activated if SUM≧2ⁿ (in this example, 2³=8). To indicate that the CARRY signal 72 and PIXEL DROP 74 are asserted, the tabulated value of INC in FIG. 6A is circled. In addition, a circled value indicates that the corresponding pixel is de-selected. For example, for INC=011 at the third clock signal (indicated as CLK/PIXEL=3), the sum is equal to 9 decimal, i.e., SUM 70=001 binary and CARRY=1. It may be noted that; out of a sequence of 8 pixels, the three pixels 3, 6 and 8 are dropped for INC=011. More generally:
Scale Factor=M/N=(n−INC)/2ⁿ.
Generally, a larger value of n provides for better scaling resolution and therefore a better fit to the display.

As mentioned, FIG. 6A tabulates decimal values of the output of the ADDER 64. FIG. 6B is similar to FIG. 6A except that values of COUNT for the 3-bit ADDER are tabulated in binary form. In addition, if the sum is ≧2³ and the CARRY signal 72 is activated, FIG. 6C provides a “C” in the corresponding clock/pixel column to signify that generation of a CARRY. In other words, FIGS. 6B and 6C together present the same information presented in FIG. 6A. Because the ADDER 64 typically does not output decimal values, FIGS. 6B and 6C are intended to illustrate values that are typically output by the ADDER 64.

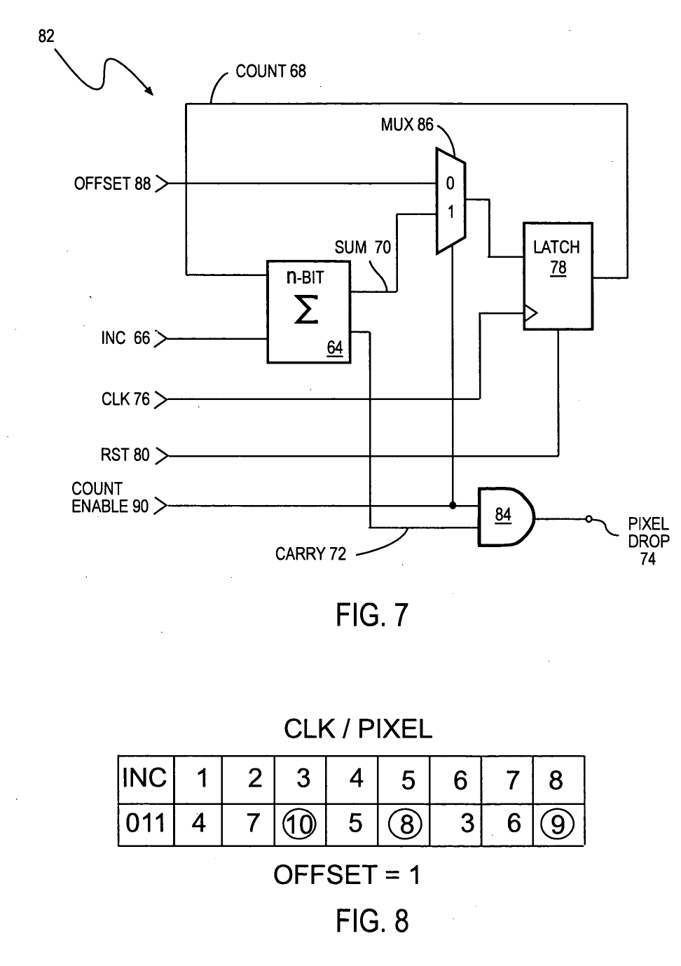

FIG. 7 shows a sampling circuit 82, which is a modified version of the circuit 62 that includes provision for defining an offset. The circuit 82 includes an n-bit ADDER 64. As with circuit 62, an INC signal 66 is input to one of the inputs of the ADDER 64 and a COUNT signal 68 is input to another input, and the ADDER 64 has output signals: SUM 70 and CARRY 72. A PIXEL DROP output 74 of the circuit instructs a pixel drop circuit (not shown) to drop a pixel in the pixel sequence that corresponds to a clock signal CLK 76. The clock signal CLK 76 is coupled to the clock input of LATCH 78. A reset signal RST 80 is coupled to the reset input of the LATCH 78. The circuit 82 also includes an AND gate 84 and a multiplexor MUX 86. The output signal SUM 70 is coupled to one input of the multiplexor MUX 86 and an OFFSET signal 88 is coupled to its other input. A signal COUNT ENABLE 90 is coupled to the select input of the multiplexor MUX 86 and to one input of the AND gate 84. The output of the multiplexor MUX 86 is coupled to the data input of the LATCH 78. The signal CARRY 72 is coupled to the second input of the AND gate 84. The output of AND gate 84 is the PIXEL DROP signal 74.

In operation, when the signal COUNT ENABLE 90 is not asserted, the multiplexor MUX 86 selects the binary offset value OFFSET signal 88 as input to the LATCH 78, and the ADDER 64 will start adding from this offset value. The OFFSET signal changes the pixel select/de-select patterns indicated in FIG. 6A by adding a decimal number equal to the binary value of the offset to each of the values tabulated.

FIG. 8 shows an example for OFFSET=001. First, reference is again made to FIG. 6A where it will be noted that, for INC=011, a pixel select/de-select pattern is shown wherein pixels #1, 2, 4, 5, and 7 are selected and pixels #3, 6, and 8 are de-selected. As the pixel select/de-select pattern of FIG. 8 shows, adding the OFFSET=001 causes a decimal 1 to be added to each entry of the pixel select/de-select pattern for INC=011 shown in FIG. 6A. In the pixel select/de-select pattern of FIG. 8, pixels #1, 2, 4, 6, and 7 are selected and pixels #3, 5, and 8 are de-selected, which is a different but equally appropriate result.

Turning to FIG. 9, a system is shown in which either the circuit 62 or 82 is provided as part of a graphics controller 92 having an interface 94 for receiving digital image data for downsizing from a camera 96. The graphics controller 92 may also receive image data for downsizing from a host 98. The image data may or may not be stored internally in a memory of the graphics controller 92. The graphics controller 92 controls a graphics display device 100, which is preferably one or more LCD panels, each of which optionally includes an embedded memory 101 for storing a frame of image data. In an LCD panel having an embedded memory, the LCD uses the frame of image data stored in the memory to refresh the screen, irrespective of whether the graphics controller 92 has written new information to the memory 101. In addition, if only a portion of the image data changes, the graphics controller 92 only writes the image data which has changed. This is in contrast to traditional display devices, in which the graphics controller 92 generally writes a complete frame of image data to the display at the screen refresh rate, such as 72 Hz, regardless of whether the image data has changed.

As mentioned, the circuit 82 is adapted so that the pixel select/de-select pattern may be modified by specifying an OFFSET 88. Turing now to FIGS. 10-12, an exemplary application of this capability is described. FIG. 10 shows an LCD panel 100 at first time t₁ and at a second time t₂. On the display device 100, a graphic image 102 is displayed. The graphic image 102 is an image created by downscaling an original image received from the camera 96, the original image having dimensions larger than the dimensions of the LCD panel. At first time t₁, a pull-down menu 104 is superimposed over a portion of the image 102. At a second time t₂, the pull-down menu 104 is no longer superimposed over the image.

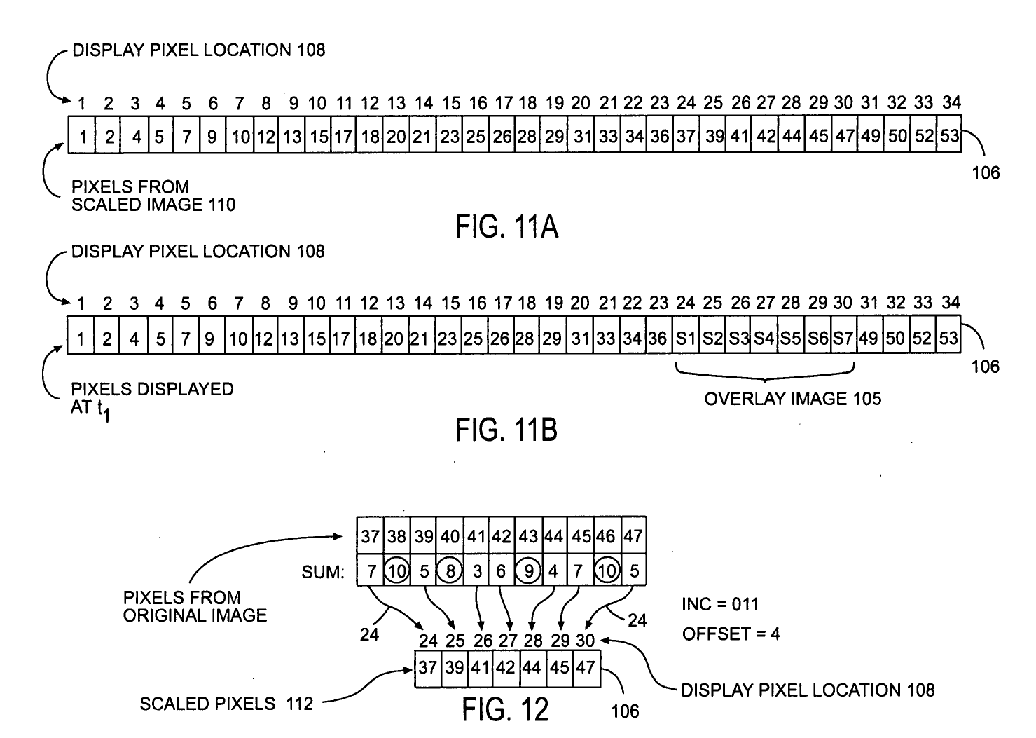

In this example, the frame for time t₁ is created by first storing the pixels for the graphic image 102 in embedded memory 101 of the LCD panel 100, and then subsequently storing the pixels for the pull-down menu 104 in memory 101. The pull-down menu 104 is superimposed on the graphic image 102 by overwriting corresponding pixels of the graphic image 102 in memory 101. As a result, the image data for these pixels from image 102, which lie “behind” the pull-down menu, are lost. FIGS. 11A and 11B illustrate how the pixels become lost.

FIGS. 11A and 11B represent a portion of the embedded memory 101 and show one line if pixels stored therein. FIG. 11A shows the contents of memory 101 after the pixels for the image 102 are stored, and FIG. 11B shows the memory after the pixels for the pull-down menu 104 are stored as overlay image 105. The numbers 108 above the line 106 correspond to pixel locations of the display device 100. Each pixel of the display device 100 is represented by a box below the display pixel location number 108. Inside each box is a pixel. For purposes of illustration, the line 106 is shown as having a length of 34 display pixels 108.

The original image pixels are selected according to the M/N sampling method of the present invention (M/N=⅜). As shown in FIG. 11A, the selected pixels are stored in the boxes below the corresponding display pixel location number 108. The original image pixels are received from the camera 96 in raster sequence so the pixel number in a box corresponds to the pixel's raster sequence number in the original image. For example, pixel 3 was selected from the original image to be displayed display pixel location 1 of the display device 100.

FIG. 11B shows the line 106 of FIG. 11A after the pixels for the pull-down menu 104 are stored. The selected pixels from the original image 110 at pixel locations 24-30 are overwritten with overlay image pixels S1-S7 for the pull-down menu. FIG. 11B shows the pixels 112 that are displayed on the LCD panel 100 at the first time t₁.

FIG. 12 shows the output (converted to decimal) of the 3-bit ADDER 64 for a sequence of clock pulses 1-8, corresponding to pixels #37-47. The pixels #37-47 are pixels from the original image received from the camera 96 to create, by downscaling, the graphic image 102. The table of FIG. 12 tabulates decimal values of SUM 70 for each clock pulse (pixel) for INC=011 and OFFSET=4. The CARRY signal 72 is activated if SUM≧2ⁿ (in this example, 2³=8). To indicate that the CARRY signal 72 and PIXEL DROP 74 are asserted, the tabulated value of INC in FIG. 12 is circled. In addition, a circled value indicates that the corresponding pixel is de-selected. The selected pixels (referred to in FIG. 12 as “scaled pixels 112”) are mapped to pixel locations 24-30 of the line 106 of the memory 101 where they at are stored, overwriting the overlay image pixels S1-S7. As FIG. 12 shows, use of an OFFSET=4 results scaled pixels 112 which exactly match the pixels scaled from the original image 110. Thus, the portion of the original image 102 that was lost when the pull-down menu 104 was displayed is seamlessly recreated.

Methods and apparatus according to the invention may be implemented in hardware, as in the circuits 62 and 82, software, or both, and machine readable media may be provided embodying one or more programs of instructions executable by the machine to perform one or more methods according to the invention. In addition, it is to be recognized that while a particular methods and apparatus for downscaling digital image data to fit a graphics display device have been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A method for downscaling digital image data, comprising the steps of:
providing a sequence of image data; and
sampling the image data so that, for every N pixels of said sequence, (N−M)+/−1 pixels of the image data are sampled, where M and N are integers and M<N.

2. The method of claim 1, further comprising displaying the sampled said image data on a display device.

3. The method of claim 2, further comprising creating a count sequence corresponding to said sequence of image data, determining whether an instance of said count sequence is less than N, and if true, selecting a corresponding instance of image data.

4. The method of claim 3, wherein N=2ⁿ, where n is a positive integer, and wherein said step of sampling samples (N−M) of said pixels for every N pixels of said sequence.

5. The method of claim 1, further comprising creating a count sequence corresponding to said sequence of image data determining whether an instance of said count sequence is less than N, and if true, selecting a corresponding instance of image data.

6. The method of claim 5, wherein N=2ⁿ, where n is a positive integer, and wherein said step of sampling samples (N−M) of said pixels for every N pixels of said sequence.

7. The method of claim 6, further comprising beginning said count sequence at an offset K.

8. The method of claim 2, wherein N=2ⁿ, where n is a positive integer, and wherein said step of sampling samples (N−M) of said pixels for every N pixels of said sequence.

9. The method of claim 1, wherein N=2ⁿ, where n is a positive integer, and wherein said step of sampling samples (N−M) of said pixels for every N pixels of said sequence.

10. The method of claim 1, further comprising transmitting the sampled said image data.

11. The method of claim 1, further comprising storing the sampled said image data in a memory.

12. An apparatus for downscaling digital image data, comprising a sampling circuit, for sampling a sequence of image data so that (N−M)+/−1 pixels of the image data are sampled for every N pixels of said sequence, where M and N are integers and M<N.

13. The apparatus of claim 12, further comprising a graphics display device for displaying the sampled said image data.

14. The apparatus of claim 13, further comprising an adding circuit for creating a count sequence corresponding to said sequence of image data, wherein said sampling circuit is adapted for determining whether an instance of said count sequence is less than N, and if true, selecting a corresponding instance of image data.

15. The apparatus of claim 14, wherein said adding circuit includes an n-bit adder, where N=2ⁿ, n is a positive integer, and wherein said sampling circuit is adapted to sample (N−M) of said pixels for every N pixels of said sequence.

16. The apparatus of claim 15, wherein said graphics display device includes one or more LCD panels.

17. The apparatus of claim 12, further comprising an adding circuit for creating a count sequence corresponding to said sequence of image data, wherein said sampling circuit is adapted for determining whether an instance of said count sequence is less than N, and if true, selecting a corresponding instance of image data.

18. The apparatus of claim 17, wherein said adding circuit includes an n-bit adder, where N=2ⁿ and n is a positive integer, and wherein said sampling circuit is adapted to sample N−M of said pixels for every N pixels of said sequence.

19. The apparatus of claim 18, wherein said adding circuit is further adapted to begin said count sequence at an offset K.

20. The apparatus of claim 13, wherein said adding circuit includes an n-bit adder, where N=2ⁿ and n is a positive integer, and wherein said sampling circuit is adapted to sample (N−M) of said pixels for every N pixels of said sequence.

21. The apparatus of claim 12, wherein said adding circuit includes an n-bit adder, where N=2ⁿ and n is a positive integer, and wherein said sampling circuit is adapted to sample N−M of said pixels for every N pixels of said sequence.

22. The apparatus of claim 12, further comprising a graphics display device for displaying transmitting the sampled said image data.

23. The apparatus of claim 12, further comprising a graphics display device for storing the sampled said image data in a memory.

24. A medium readable by a machine embodying a program of instructions executable by the machine to perform a method for down-scaling digital image data, comprising the steps of:
providing a sequence of image data; and
sampling the image data so that (N−M)+/−1 pixels of the image data are sampled for every N pixels of said sequence, where M and N are integers and M<N.

25. The medium of claim 24, wherein the method further comprises displaying the sampled said image data on the display.

26. The medium of claim 25, wherein the method further comprises creating a count sequence corresponding to said sequence of image data, determining whether an instance of said count sequence is less than N, and if true, selecting a corresponding instance of image data.

27. The medium of claim 26, wherein N=2ⁿ, where n is a positive integer, and wherein said step of sampling samples N−M of said pixels for every N pixels of said sequence.

28. The medium of claim 24, creating a count sequence corresponding to said sequence of image data, determining whether an instance of said count sequence is less than N, and if true, selecting a corresponding instance of image data.

29. The medium of claim 28, wherein N=2ⁿ, where n is a positive integer, and wherein said step of sampling samples N−M of said pixels for every N pixels of said sequence.

30. The medium of claim 29, further comprising beginning said count sequence at an offset K.

31. The medium of claim 25, wherein N=2ⁿ, where n is a positive integer, and wherein said step of sampling samples N−M of said pixels for every N pixels of said sequence.

32. The medium of claim 24, wherein N=2ⁿ, where n is a positive integer, and wherein said step of sampling samples N−M of said pixels for every N pixels of said sequence.

33. The medium of claim 24, further comprising transmitting the sampled said image data.

34. The medium of claim 24, further comprising storing the sampled said image data in a memory.

35. A system for displaying images, comprising a camera, a host, a graphics display device, and a graphics controller, wherein said graphics controller comprises an apparatus for downscaling digital image data, said apparatus comprising a sampling circuit, for sampling a sequence of image data so that (N−M)+/−1 pixels of the image data are sampled for every N pixels of said sequence; where M and N are integers and M<N.

36. The system of claim 35, wherein said graphics display device comprises an embedded memory for storing the sampled said image data.

37. The system of claim 36, wherein said apparatus for downscaling further comprises an adding circuit for creating a count sequence corresponding to said sequence of image data, wherein said sampling circuit is adapted for determining whether an instance of said count sequence is less than N, and if true, selecting a corresponding instance of image data.

38. The system of claim 37, wherein said adding circuit includes an n-bit adder, where N=2ⁿ, n is a positive integer, and wherein said sampling circuit is adapted to sample (N−M) of said pixels for every N pixels of said sequence.

39. The system of claim 38, wherein said graphics display device includes one or more LCD panels.

40. The system of claim 35, wherein said apparatus for downscaling further comprises an adding circuit for creating a count sequence corresponding to said sequence of image data, wherein said sampling circuit is adapted for determining whether an instance of said count sequence is less than N, and if true, selecting a corresponding instance of image data.

41. The system of claim 40, wherein said adding circuit includes an n-bit adder, where N=2ⁿ and n is a positive integer, and wherein said sampling circuit is adapted to sample (N−M) of said pixels for every N pixels of said sequence.

42. The system of claim 41, wherein said adding circuit is further adapted to begin said count sequence at an offset K.

43. The system of claim 36, wherein said adding circuit includes an n-bit adder, where N=2ⁿ and n is a positive integer, and wherein said sampling circuit is adapted to sample (N−M) of said pixels for every N pixels of said sequence.

44. The system of claim 35, wherein said apparatus for downscaling further comprises an adding circuit for creating a count sequence corresponding to said sequence of image data, and wherein said adding circuit includes an n-bit adder, where N=2ⁿ and n is a positive integer, and wherein said sampling circuit is adapted to sample (N−M) of said pixels for every N pixels of said sequence.

45. The system of claim 35, wherein said system is adapted for transmitting the sampled said image data.

46. The system of claim 35, Wherein said system is adapted for storing the sampled said image data in a memory.

47. The system of claim 35, wherein said graphics display device is adapted for displaying the sampled said image data.
